(19) United States
(12) Patent Application Publication
(10) Pub. No.: US 2017/0026620 A1
(43) Pub. Date: Jan. 26, 2017

(54) APPARATUS AND A METHOD TO DETERMINE THE CONCENTRATION OF AN ANALYTE

(71) Applicants: Venkatasubramaniam Kalambur, Bangalore (IN); Ashish Kumar Lal, Bangalore (IN); Vishal Prabhu, Bangalore (IN)

(72) Inventors: Venkatasubramaniam Kalambur, Bangalore (IN); Ashish Kumar Lal, Bangalore (IN); Vishal Prabhu, Bangalore (IN)

(21) Appl. No.: 15/216,835

(22) Filed: Jul. 22, 2016

(30) Foreign Application Priority Data
Jul. 24, 2015 (IN) 816/KOL/2015

(51) Int. Cl. H04N 7/18; G06K 9/46; G06K 9/62; G06T 7/40; H04N 5/235

(52) U.S. Cl. CPC H04N 7/185; G06T 7/408; H04N 5/235; G06K 9/6201; G06K 9/4661; G06T 2207/10056

(57) ABSTRACT

To determine a concentration of an analyte in a sample, a matrix impregnated with one or more reagents is contacted with the sample. Individual images of the matrix are captured. A memory includes image processing module configured to generate a composed image of the matrix from the captured images. The intensity of the colour of the composed image developed on the matrix is measured, wherein the intensity of the colour provides information on the concentration of the analyte in the sample. The determined colour value is selected and compared with a set of calibrated colour values to find the concentration of an analyte present in a given sample.

### CROSS-REFERENCE TO RELATED APPLICATIONS

This application claims the benefit of IN 816/KOL/2015 filed on Jul. 24, 2015, which is hereby incorporated by reference in its entirety.

### TECHNICAL FIELD

Embodiments relate to an apparatus and method for determining the concentration of an analyte in a given sample.

### BACKGROUND

An apparatus and method for determining the concentration of an analyte have been disclosed. Concentration of analytes present in a sample may be determined using a matrix that is impregnated with one or more reagents. The analytes in the sample react with the reagents in the matrix to produce a colour change. The intensity of the colour change corresponds to the concentration of the analyte present in the sample. The method of determining the concentration of the analyte may be automated by use of images of the matrix once it has been contacted with the sample containing the analyte. Some apparatuses may include an image capturing unit configured to capture images of a matrix impregnated with one or more reagents. The apparatuses may also include a processing unit that processes images, wherein the individual images are enhanced to apply corrections for brightness, exposure, contrast, sharpness, noise reduction, etc. in order to obtain a clear picture of the matrix. The processing unit may also be configured to output the result with respect to the concentration of the analyte depending on the intensity of the colour developed on the matrix.

However, the images obtained of the matrix may not clearly depict the developed colour as there may be several exposure issues. The normal room illumination is not often uniform, causing some parts of the image to be brighter than others. Although mobile phone cameras perform automatic exposure control, if the variation in brightness of a particular location of the matrix is greater than the usable dynamic range of the camera, the final image may have very dark or very bright areas. Glare in an image is a specific case where a certain part of the image is so bright that all colour information is lost or significantly distorted. Furthermore, decreasing the exposure to reduce the overexposed areas does not help because it causes other parts of the image to get darker. Therefore, the accuracy of determining the exact colour on the matrix falls drastically.

### SUMMARY AND DESCRIPTION

The scope of the present invention is defined solely by the appended claims and is not affected to any degree by the statements within this summary. The present embodiments may obviate one or more of the drawbacks or limitations in the related art.

The object of the embodiments is to improve the reliability for determination of concentration of the analyte in the sample.

Embodiments relate to an apparatus for determining the concentration of an analyte in a given sample. The apparatus includes an image capturing module having an exposure control unit to capture at least two individual images of a matrix impregnated with one or more reagents, wherein the at least two individual images have varying exposures; a processing unit; and a memory coupled to the processing unit.

Embodiments also relate to a method for determining the concentration of an analyte in a given sample. The method includes contacting a matrix impregnated with one or more reagents with the sample; capturing an individual image of the matrix; and measuring the intensity of the colour developed on the matrix, wherein the intensity of the colour provides information on the concentration of the analyte in the sample.

Based on the aforementioned apparatus, embodiments aim to achieve the object in that the memory includes an image processing module capable of generating a composed image of the matrix from the captured individual images having uniform exposure. The image processing module determines from the composed image the colour value of the colour developed on a defined location on the matrix. The image processing module selects and compares the determined colour value with a set of calibrated colour values to find the concentration of an analyte present in a given sample.

Embodiments relate to an apparatus for determination of concentration of an analyte in a given sample. The apparatus includes an image capturing module (camera) to capture images of a matrix on which one or more reagents are impregnated. The matrix is a solid phase substrate that absorbs the sample and transmits the sample to the impregnated reagent area. The matrix may be, for example, cellulose or a nitrocellulose membrane. The one or more reagents assist in detection of one or more analytes that may be present in the sample. The reagents present on the matrix react with the analyte to produce a colour change. The image capturing module has an exposure control unit that enables capturing images at different exposures. The exposure control unit may be manual or automatic. One individual image of the matrix is captured at an exposure optimized for a region of interest of the matrix. Another individual image is captured with an exposure optimized for a different region of the matrix. The apparatus also includes a processing unit and a memory coupled to the processing unit that process the images to enhance the image quality.

According to an embodiment, the memory includes an image processing module that is configured to generate a composed image of the matrix. The composed image is generated from at least two captured images of the matrix at different exposures. The image processing module is further configured to determine from the composed image the colour value of the colour developed on a defined location on the matrix. The image processing module is configured to select and compare the determined value with a set of calibrated colour values to find the concentration of an analyte present in a given sample. The colour value is the indication of how much of each of red, blue and green is used. The colour value is, for example, the RGB value and is expressed as an RGB triplet, each component of which may vary from zero to a defined maximum value.

According to another embodiment, the composed image of the matrix is created by choosing well exposed areas from each image and fusing the areas together into a single image. A composed image is an image in which the colour information of the matrix is accurate. The pixels of the sensor in the camera capture photons during the exposure. The brighter the captured area, the more photons are collected by the pixels. After exposure, values are assigned to each pixel depending upon the photon quantity. Based on these pixel values, optimally exposed areas from each individual image are chosen. Such optimally exposed areas have pixel values that are not too high or too low and therefore define accurate colour information. Choosing optimally exposed areas provides that all the areas of the matrix are optimally exposed so as to avoid very bright or very dark patches in the image.

According to another embodiment, the processing unit in the apparatus is a processor of a mobile device. The processor of a mobile device is capable of performing such operations. Using a mobile device makes the apparatus user friendly and capable of being conveniently operated on the go.

According to an embodiment, the image capturing module is configured to capture at least two images of the matrix is a camera integrated with a mobile device, therefore making the apparatus hassle free and convenient. Using a mobile device provides that no additional equipment is required for capturing images of the matrix.

According to a further embodiment, the memory further includes a communication module configured to communicate the composed image to another user or device through a network. The apparatus is therefore capable of connecting to a network and transferring the data to a remote processing device. Thus, further analysis of the collected data is easier and quick.

According to a further embodiment, the image processing module is also configured to determine the concentration of the analyte present in the sample based on the intensity of the colour developed on the matrix. The greater the intensity of the colour developed, the greater concentration of the analyte.

Based on the aforementioned method, embodiments aim to achieve the objective by obtaining at least two individual images having varying exposures, generating a composed image of the matrix from the captured images, determining from the composed image the colour value of the colour developed on the matrix, and finding the concentration of an analyte present in a given sample from a set of calibrated values.

Embodiments also relate to a method for determination of concentration of an analyte in a given sample. According to an embodiment, the method includes contacting a matrix impregnated with one or more reagents with a sample including analytes. The analyte reacts with the reagents present on the matrix to produce a colour change. The method further includes capturing individual images of the matrix. The matrix is capable of detecting more than one analyte in the sample because of the presence of more than one reagent. The intensity of the colour developed on the matrix is measured. In the presence of the analyte, the reagent on the matrix produces a change in colour. The intensity of the colour provides information on the concentration of the analyte present in the sample.

According to an embodiment, the method further includes obtaining at least two individual images having varying exposures, generating a composed image of the matrix from the captured images, determining from the composed image the colour value of the colour developed on a defined location on the matrix, and selecting and comparing the determined value with a set of calibrated values to find the concentration of an analyte present in a given sample. The generated composed image provides more accurate information in comparison to any other image captured of the matrix. Therefore, on comparison, the accuracy of the result obtained is greater.

According to an embodiment, the images are processed to create a composed image of the matrix by choosing the optimally exposed areas from each image and fusing the areas together. The fusion leads to formation of an image in which the colour information of all the areas is correct. The underexposed or exposed areas of the image are eliminated. The composed image makes determination of the colour value of the colour more accurate and therefore the determination of concentration of the analyte in the sample is more precise.

According to an embodiment, the colour change on the matrix is measured using the composed image. The composed image has higher clarity in comparison to those that have not been fused. All the areas of the image are optimally exposed, making measurement of colour change more accurate.

According to an embodiment, the images are processed using a processing unit. The processing unit may be, for example, a processor of a mobile device.

According to an embodiment, the composed image is communicated to another user or device through a network enabling further analysis of the image.

### BRIEF DESCRIPTION OF THE DRAWINGS

FIG. 1 illustrates a schematic block diagram according to an embodiment of an apparatus.

FIG. 2 illustrates a flowchart according to an embodiment of a method.

FIG. 3A illustrates an embodiment of an image of a matrix captured under extreme illumination conditions and high exposure.

FIG. 3B illustrates another embodiment of an image of a matrix captured with low exposure.

FIG. 3C illustrates an embodiment of an image created by fusing images represented in FIGS. 3A and 3B.

### DETAILED DESCRIPTION

Hereinafter, embodiments for carrying out the embodiments are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

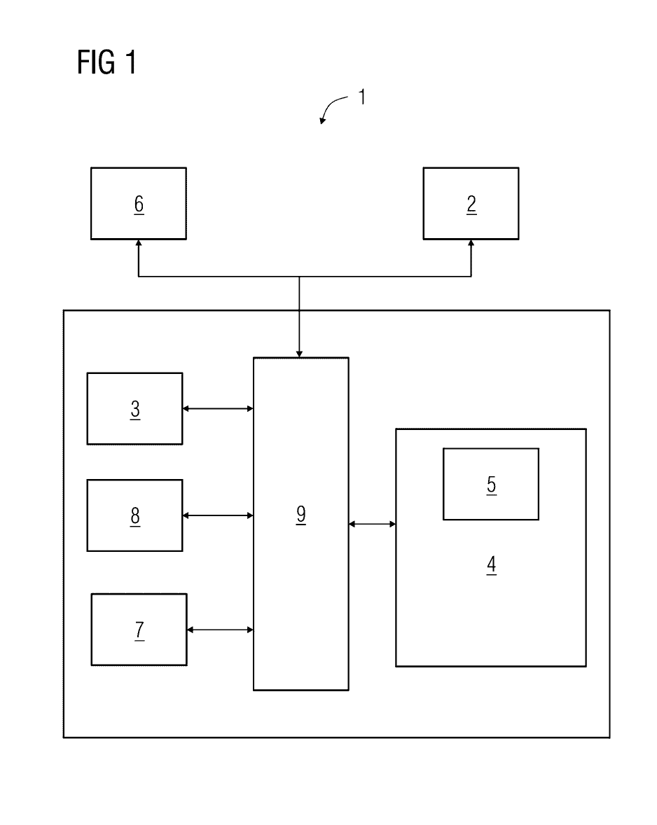

FIG. 1 illustrates a block diagram of an embodiment of an apparatus 1. The apparatus 1 is used for the determination of concentration of an analyte present in a given sample. The apparatus 1 includes s an image capturing module 2 through which several images of a matrix may be captured. The image capturing module 2 may be, for example, a camera integrated with a mobile device. The image capturing module 2 has an exposure control unit (controller) through which the exposure of the image may be monitored and controlled. The exposure control unit may be automatic or manual in function. The matrix is a solid substrate on which one or more reagents may be impregnated. The reagents are capable of reacting with an analyte that may be present in the given sample. On reacting with the analyte, a new colour is developed on the matrix. The intensity of the colour developed is proportional to the concentration of the analyte present in the sample. The image capturing module 2 captures individual images of the matrix at varying exposure levels with the help of the exposure control unit. Capturing individual images at varying exposure levels provides that there is at least one image in which all the areas on the matrix are well exposed.

The apparatus 1 further includes a processing unit 3. The processing unit 3 may be, for example, a processor of a mobile device. The processing unit 3 may include one or more processors, such as a single central-processing unit, or a plurality of processing units, commonly referred to as a parallel processing environment. Each of the processors may be any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processing unit 3 may also include embedded controllers, such as generic or programmable logic devices or arrays, application specific integrated circuits, single-chip computers, and the like. The processing unit 3 is coupled with a memory 4 that includes a set of instructions that enable processing of the captured images. The memory 4 may be volatile memory and non-volatile memory. A variety of computer-readable storage media may be stored in and accessed from the memory 4. The memory 4 may include any suitable elements for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and the like. The memory 4 further includes an image processing module 5. The image processing module 5 may be stored in the form of machine-readable instructions on any of the above mentioned storage media and may be executed by the processing unit 3.

The image processing module 5 is configure to generate a composed image of the matrix by selecting well exposed areas from each captured image and fusing the areas together to form a new composed image. Generating a composed image by selecting well exposed areas is known as exposure fusion. Exposure fusion computes the desired image by keeping only the best parts in a multi-exposure image sequence. The pixels of the sensor in the camera capture photons during the exposure. The more photons collected by the pixels, the brighter the captured area. After exposure, values are assigned to each pixel depending upon the photon quantity. Based on these pixel values, optimally exposed areas from each individual image are chosen. Such optimally exposed areas have pixel values that are not too high or too low and therefore define accurate colour information. A composed image is generated by multi resolution blending. In multi-resolution blending the input images are decomposed into a Laplacian pyramid. The Laplacian pyramid contains band-pass filtered versions at different scales. Blending is carried out at each level separately. Multi resolution blending is an effective technique because it blends image features instead of intensities of colours in the image. However, multi-resolution blending is only one of the techniques by which a composed image may be generated. Embodiments are not limited to use of a multi-resolution blending technique for generation of a composed image. Other techniques may be used.

Once the composed image is generated, the image processing module 5 is configured to determine from the composed image the RGB value of the colour developed on the matrix. The RGB value is the indication of how much of each of red, blue and green is used. The colour is expressed as an RGB triplet, each component of which may vary from zero to a defined maximum value. The image processing module 5 is further configured to determine the concentration of the analyte in the sample. As the intensity of the colour developed on the matrix is proportional to the concentration of the analyte present in the sample, determination of the concentration of the analyte based on the colour developed is possible. The image processing module is configured to compute the concentration of the analyte in the sample by comparing the intensity value of the pixel of the composed image of the matrix with a predetermined set of values. The RGB values obtained are compared with a set of calibrated colour values. The calibrated colour values are predetermined and give information regarding the concentration of the analyte in proportion to each RGB value. The apparatus may also include a display unit 6 to display the results. The display unit 6 may also be used to display the captured individual images and the generated composed image. Therefore, the user is able to check the quality of the image formed by the image processing module 5. The apparatus may also include a communication interface 7 that is configured for receiving images of the matrix from another user or device when connected to a network. The results and data related to the matrix are stored in a storage unit 8 and may used for further analysis. The bus 9 acts as an interconnect between the components of the apparatus 1.

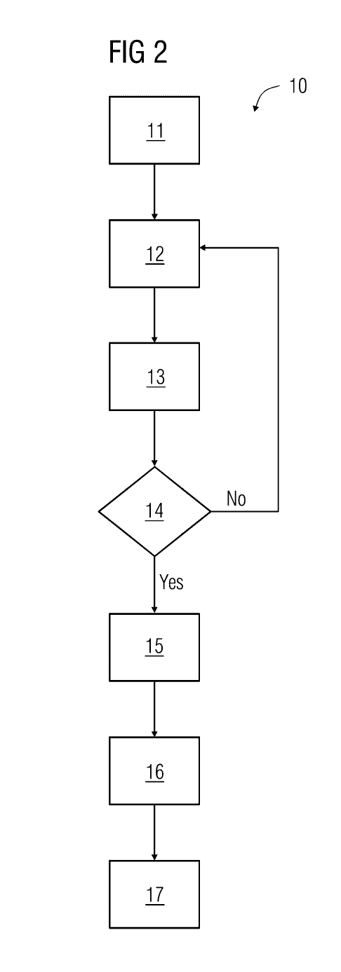

FIG. 2 provides an illustration of a flowchart 10 of an embodiment. Act 11 involves bringing in contact a matrix impregnated with one or more reagents, with a sample including an analyte. The reagents impregnated on the matrix are capable of reacting with the analyte in the sample and producing a change in colour. The higher the concentration of analyte, the deeper the intensity of the colour developed on the matrix. At act 12, individual images of the matrix are captured. The images may be captured using, for example, a camera of a mobile device. The images of the matrix are obtained at different exposure levels by the exposure control unit. Obtaining images at different exposure levels provides that all the areas of the matrix are well exposed in at least one of the captured images. Alternatively, in Act 12, the images of the matrix at varying exposure levels may also be received from another user or device through a communication interface for further processing. The images at varying exposures are then fused together at act 13. The fusion is carried out by the image processing module 5 present in the memory 4 coupled to the processing unit 3. The images are layered on top of each other and the well-exposed areas from each image are chosen and are fused. The fused portions of the different images make one composed image of the matrix. At act 14, the image processing module 5 analyses the composed image to see if all the areas of the matrix are well exposed and if there is no loss of colour information. In an event where the composed image has areas that are under or overexposed, acts 12 and 13 are repeated until the final image composed is a well exposed image. The image processing module 5 may also be configured to display the generated composed image on the display unit 6 and obtain an input from the user with regard to the accuracy of the image. Once the image processing module 5 confirms that the composed image has all areas well-exposed, act 15 is carried out in which the RGB value of the colour developed on the matrix is determined from the composed image. At act 16, the concentration of the analyte in the sample is determined by comparing a set of calibrated RGB values. The calibrated RGB values are predetermined and provide information regarding the concentration of the analyte in proportion to each RGB value. The RGB value may also be determined directly from the pixels of the composed image. The result obtained is then displayed on the display unit 6 at act 17. The obtained data and results may also be stored or may be transferred to another device or user through a communication interface 7 when connected to a network.

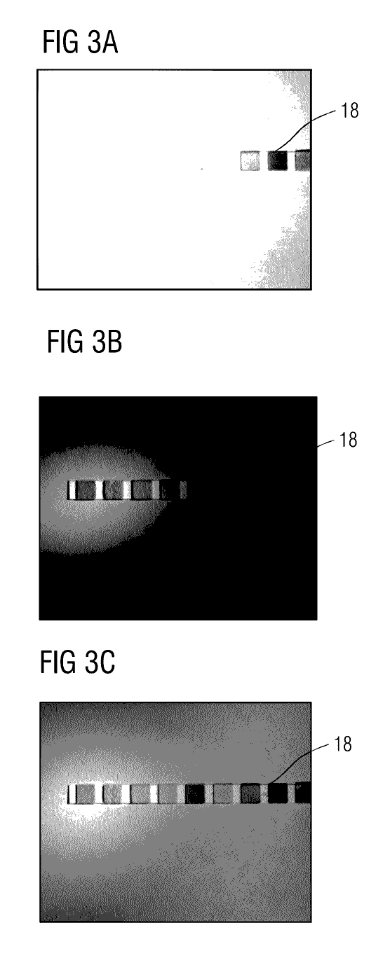

FIG. 3A depicts an illustration of an embodiment of an image of a matrix 18 captured under extreme illumination conditions and high exposure. The matrix has several pads, each pad having one reagent impregnated. On contacting the matrix 18 with a sample, in the presence of analytes, a colour is developed on the pad. Due to the presence of several pads on the same matrix 18, the sample may be analyzed for the presence of more than one analyte. Once the reaction between the analyte and the reagent is complete, individual images of the matrix 18 are obtained. The images are of varying exposures. FIG. 3A depicts an embodiment of an image of such matrix 18 with high exposure and high illumination conditions. In such extreme conditions of illumination and exposure, the colour information presented by one half of the matrix 18 is lost. FIG. 3B depicts an embodiment of an image of the matrix 18 with low exposure. If the exposure levels of FIG. 3A are reduced, the image becomes darker. Although the earlier bright portion of the image is visible, the colour information presented on the other half of the matrix 18 is lost due to darkness. FIG. 3C depicts an embodiment of an image generated by fusing the images depicted in FIG. 3A and FIG. 3B. The well-exposed areas of images in FIG. 3A and FIG. 3B are chosen and are fused together resulting in a composed image depicted in FIG. 3C. Therefore, the colour information is preserved for correct analysis. A composed image provides an accurate determination of concentration of analyte that is present in the given sample.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An apparatus comprising:
a processing unit; and
a memory coupled to the processing unit, the memory comprising:
an image processing module configured to:
generate a composed image of a matrix from at least two images of the matrix;
determine a value of colour at a specific location on the composed image of the matrix; and
compute a concentration of an analyte present in a given sample based on the determined value of the colour.

2. The apparatus of claim 1, further comprising:
an image capturing module comprising:
an exposure control unit configured to capture the at least two images of the matrix impregnated with one or more reagents, wherein the at least two images have varying exposures.

3. The apparatus of claim 1, wherein the image processing module is configured to:
select optimally exposed areas from each of the at least two images; and
fuse the optimally exposed areas in the at least two images to generate the composed image of the matrix.

6. The apparatus of claim 1, wherein the value of the colour is an intensity value of pixels in the composed image of the matrix.

7. The apparatus of claim 6 wherein the image processing module is further configured to:
compare the intensity value of the pixels with a predetermined set of values; and
compute the concentration of the analyte in the sample based on the outcome of the comparison, wherein the intensity value of pixels in the composed image of the matrix corresponds to the concentration of the analyte in the sample.

8. A method for determining the concentration of an analyte in a given sample, the method comprising:
generating a composed image of a matrix impregnated with one or more reagents from at least two images of the matrix;
determining pixel intensity values at a specific location in the composed image the matrix; and
computing a concentration of the analyte present in the given sample based on the determined pixel intensity values.

9. The method of claim 8, wherein computing the concentration of the analyte in the given sample comprises:
comparing the pixel intensity values with a predetermined set of values; and
computing the concentration of the analyte in the sample based on the outcome of the comparison, wherein the pixel intensity values in the composed image of the matrix corresponds to concentration of the analyte in the sample.

10. The method of claim 8, further comprising:
capturing a plurality of images of the matrix impregnated with one or more reagents.

11. The method of claim 8 wherein generating the composed image of the matrix comprises:
choosing one or more optimally exposed areas of the at least two images; and
fusing the one or more optimally exposed areas in the at least two images to generate a composed image of the matrix.

12. The method of claim 8 further comprising:
measuring the colour change from the composed image of the matrix.

13. The method of claim 8 further comprising:
receiving the composed image from a device through a network.

14. A non-transitory computer-readable storage medium having machine-readable instructions stored therein, that when executed by a processor, cause the processor to perform method steps comprising:
generating a composed image of a matrix impregnated with one or more reagents from the at least two images of the matrix; and
determining from the composed image a colour value developed on a defined location on the matrix; and
computing a concentration of an analyte present in the given sample based on the determined value of the colour.

15. The storage medium of claim 14, wherein the instructions cause the processor to perform the method steps comprising:
choosing one or more optimally exposed areas from each image of the at least two images; and
fusing the one or more optimally exposed areas together.

16. The storage medium of claim 14, wherein the instructions cause the processor to perform the method steps comprising:
comparing the intensity value of pixels of the composed image of the matrix with a predetermined set of values, wherein an intensity of pixels in the composed image of the matrix corresponds to concentration of the analyte in the sample.
